(19) United States
(12) Patent Application Publication
(10) Pub. No.: US 2020/0096638 A1
(43) Pub. Date: Mar. 26, 2020

(54) METHOD AND APPARATUS FOR ACQUIRING DEPTH IMAGE, AND ELECTRONIC DEVICE

(71) Applicant: Guangdong Oppo Mobile Telecommunications Corp., Ltd., Dongguan (CN)

(72) Inventor: Yan Chen, Dongguan (CN)

(21) Appl. No.: 16/535,841

(22) Filed: Aug. 8, 2019

(30) Foreign Application Priority Data
Sep. 26, 2018 (CN) 201811124929.X

(51) Int. Cl. G01S 17/42; G06T 5/00; G06T 5/20; G06T 7/521; G01S 17/89; G01S 7/493; G01S 7/481

(52) U.S. Cl. CPC G01S 17/42; G06T 5/002; G06T 5/20; G06T 7/521; G06T 2207/10028; G01S 7/493; G01S 7/4813; G06T 2207/20028; G01S 17/89

(57) ABSTRACT

A method for acquiring a depth image, an apparatus for acquiring a depth image, and an electronic device are provided. The method includes the following. Light is emitted to a target object. Light reflected by the target object is received and sampling is performed a number of times, to obtain multiple phase maps. The multiple phase maps are filtered to obtain multiple filtered phase maps. The depth image is formed according to the multiple filtered phase maps.

### CROSS-REFERENCE TO RELATED APPLICATION(S)

This application claims priority to Chinese Patent Application No. 201811124929.X, filed on Sep. 26, 2018, the disclosure of which is hereby incorporated by reference in its entirety.

### TECHNICAL FIELD

The disclosure relates to the field of imaging technology, and more particularly to a method for acquiring a depth image, an apparatus for acquiring a depth image, and an electronic device.

### BACKGROUND

In the related art, a depth image formed by a time of flight (TOF) depth camera has problems such as low accuracy, low resolution, and poor image quality, thereby making it difficult to obtain depth information of high accuracy.

### SUMMARY

Implementations of the present disclosure provide a method for acquiring a depth image, an apparatus for acquiring a depth image, and an electronic device.

The method for acquiring a depth image of the implementations of the disclosure includes the following. Light is emitted to a target object. Light reflected by the target object is received and sampling is performed a number of times, to obtain multiple phase maps. The multiple phase maps are filtered, to obtain multiple filtered phase maps. The depth image is formed according to the multiple filtered phase maps.

The apparatus for acquiring a depth image of the implementations of the disclosure includes a light emitter, a light receiver, and a processor. The light emitter is configured to emit light to a target object. The light receiver is configured to receive light reflected back by the target object and perform sampling a number of times, to obtain multiple phase maps. The processor is configured to filter the multiple phase maps and form the depth image according to the multiple filtered phase maps.

The electronic device of the implementations of the disclosure includes a casing and the above apparatus for acquiring a depth image received in the casing.

### BRIEF DESCRIPTION OF THE DRAWINGS

The above and/or further aspects and advantages of the present disclosure will be apparent and readily understood from the description of the embodiments in conjunction with the accompanying drawings.

FIG. 1 is a schematic flowchart illustrating a method for acquiring a depth image according to some implementations of the present disclosure.

FIG. 2 is a schematic diagram illustrating an apparatus for acquiring a depth image according to some implementations of the present disclosure.

FIG. 3 is a schematic diagram illustrating phase maps and an amplitude map according to some implementations of the present disclosure.

FIG. 4 to FIG. 7 are schematic flowcharts illustrating methods for acquiring a depth image according to some implementations of the present disclosure.

FIG. 8 and FIG. 9 are schematic diagrams illustrating application of a method for acquiring a depth image according to some implementations of the present disclosure.

FIG. 10 is a schematic flowchart illustrating a method for acquiring a depth image according to some implementations of the present disclosure.

FIG. 11 is a schematic plan view of an electronic device according to some implementations of the present disclosure.

FIG. 12 is a schematic diagram of connection between a computer readable storage medium and an electronic device according to some implementations of the present disclosure.

### DETAILED DESCRIPTION

Embodiments of the present disclosure are described in detail below. Examples of the embodiments are illustrated in the drawings, in which the same or similar reference numerals indicate the same or similar elements or elements having the same or similar functions. The embodiments described below with reference to the drawings are intended to be illustrative and are not to be construed as limiting of the disclosure.

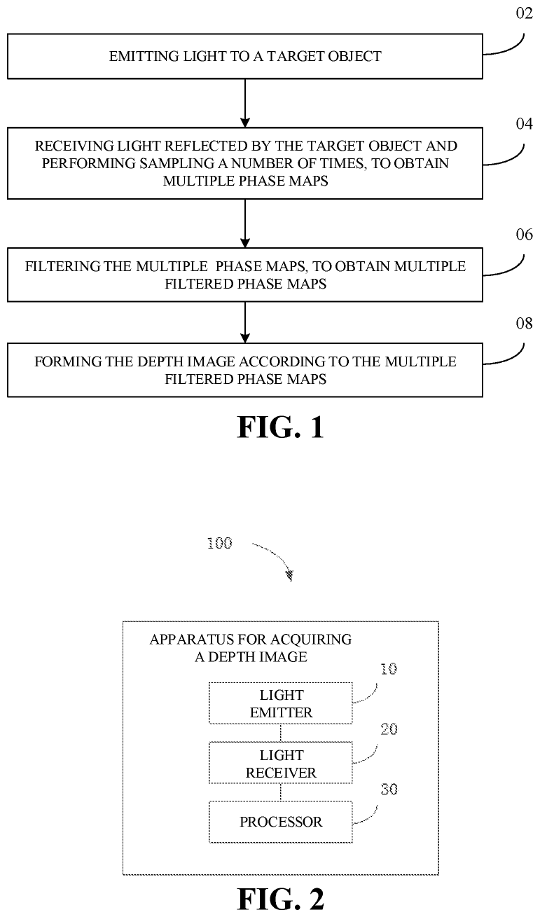

Referring to FIG. 1, a method for acquiring a depth image according to implementations of the disclosure includes the following.

At operation 02, light is emitted to a target object.

At operation 04, light reflected by the target object is received and sampling is performed a number of times, to obtain multiple phase maps.

At operation 06, the multiple phase maps are filtered to obtain multiple filtered phase maps.

At operation 08, the depth image is formed according to the multiple filtered phase maps.

Referring to FIG. 2, an apparatus 100 for acquiring a depth image according to implementations of the disclosure includes a light emitter 10, a light receiver 20, and a processor 30. The light emitter 10 is configured to emit light to a target object. The light receiver 20 is configured to receive light reflected back by the target object and perform sampling a number of times, to obtain multiple phase maps. The processor 30 is configured to filter the multiple phase maps to obtain multiple filtered phase maps and form the depth image according to the multiple filtered phase maps.

That is, in the implementations of the disclosure, the method for acquiring a depth image can be implemented with the apparatus 100 for acquiring a depth image, where the operation 02 can be implemented with the light emitter 10, the operation 04 can be implemented with the light receiver 20, and the operations 06 and 08 can be implemented with the processor 30.

In some examples, the apparatus 100 for acquiring a depth image is, for example, a time of flight (TOF) depth camera. The TOF depth camera can calculate and obtain the depth image by performing sampling two or four times. Accordingly, the multiple phase maps may be at least two phase maps, such as two phase maps, four phase maps, and the like. The implementation of the disclosure takes a manner in which four phase maps are obtained by performing sampling four times as an example. In this example, after the light emitter 10 emits laser light into the scene, the light receiver 20 can receive light reflected and perform sampling four times to obtain four phase maps. The sampling is performed once every 90 degrees, for example, phases corresponding to the four phase maps are 0 degrees, 90 degrees, 180 degrees, and 270 degrees, respectively. Furthermore, pixels of the four phase maps are in one-to-one correspondence.

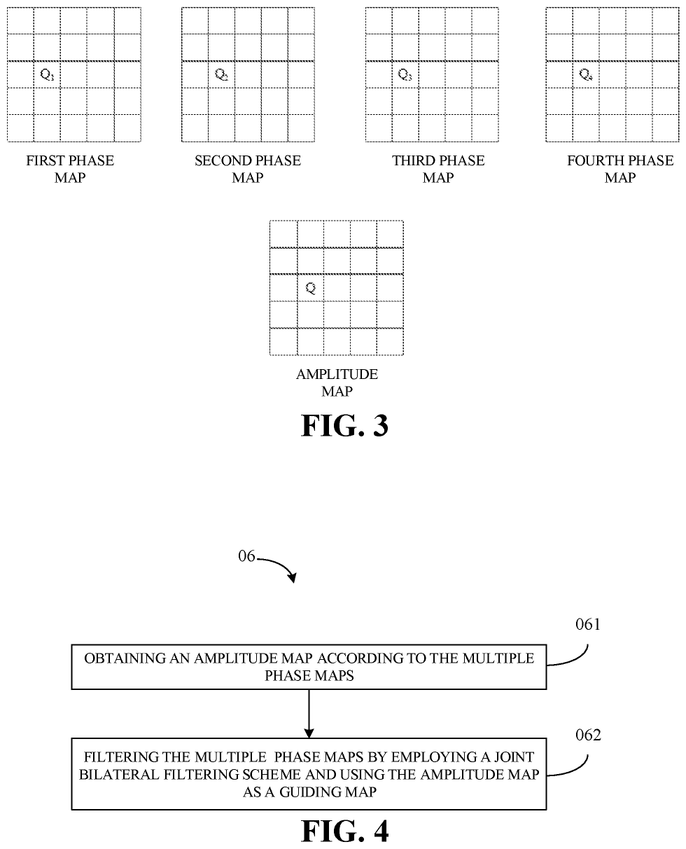

Referring to FIG. 3, the four phase maps are respectively referred to as a first phase map, a second phase map, a third phase map, and a fourth phase map. In the related art, without filtering the four phase maps, depth information of the depth image is obtained as follows. A phase difference between the light emitted and the light reflected is

$$ϕ = arctan ( \frac{{Q}_{3} - {Q}_{4}}{{Q}_{1} - {Q}_{2}} ) ,$$

where Q₁ can be a pixel value of a pixel of the first phase map, Q₂ can be a pixel value of a pixel of the second phase map, where the pixel of the second phase map locates at a position of the second phase map the same as a position of the first phase map where the pixel of the first phase map locates, Q₃ can be a pixel value of a pixel, which locates at the same location as the pixel of the first phase map, of the third phase map, and Q₄ can be a pixel value of a pixel, which locates at the same location as the pixel of the first phase map, of the fourth phase map. Hence, depth information of the scene corresponding to the pixel of the first phase map is

$$d = \frac{c}{2 f} \cdot \frac{ϕ}{2 π} ,$$

where c is the speed of light and ƒ is the light-emitting frequency (modulation frequency) of a laser. For example, the pixel of the first phase map locates at an upper left position of the first phase map, the pixel of the second phase map locates an upper left position of the second phase map, the pixel of the third phase map locates at an upper left position of the third phase map, and the pixel of the fourth phase map locates at an upper left position of the fourth phase map.

However, a depth image formed by the TOF depth camera has problems such as low accuracy, low resolution, and poor image quality, thereby making it difficult to obtain depth information of high accuracy. Therefore, in the implementations of the disclosure, according to the method for acquiring a depth image and the apparatus 100 for acquiring a depth image, the multiple phase maps are filtered, such that the depth image formed according to the multiple filtered phase maps has higher accuracy, and thus the depth information of higher accuracy can be obtained. Furthermore, in the implementations of the disclosure, according to the method for acquiring a depth image and the apparatus 100 for acquiring a depth image, the multiple phase maps are filtered. Since the multiple phase maps contain more original data, this filtering manner is closer to the hardware layer, and the depth image formed according to the multiple filtered phase maps is more accurate.

In some examples, the multiple phase maps can be filtered with a joint bilateral filtering scheme, a trilateral filtering scheme, a guided filtering scheme, and the like. In the implementations of the disclosure, the multiple phase maps are filtered with the joint bilateral filtering scheme for illustration.

Referring to FIG. 4, in some implementations, the operation 06 includes the following.

At operation 061, an amplitude map is obtained according to the multiple phase maps.

At operation 062, the multiple phase maps are filtered by employing the joint bilateral filtering scheme and using the amplitude map as a guiding map.

Returning to FIG. 2, in some implementations, the processor 30 is configured to obtain the amplitude map according to the multiple phase maps, and to filter the multiple phase maps by employing the joint bilateral filtering scheme and using the amplitude map as the guiding map.

That is, the operations 061 and 062 can be implemented with the processor 30.

In an example, when filtering the multiple phase maps with the joint bilateral filtering scheme, the joint bilateral filtering scheme determines a weight of the filtering by using the guiding map. The guiding map is for guiding the filtering, such as providing information for indicating which portions are edges and which portions are areas. Therefore, in the implementations of the disclosure, the amplitude map is obtained according to the multiple phase maps, and is used as the guiding map for the joint bilateral filtering scheme. The joint bilateral filtering scheme can effectively filter out noise (such as Gaussian white noise) in each of the multiple phase maps, so that pixels of the depth image generated are accurately distributed in a depth direction.

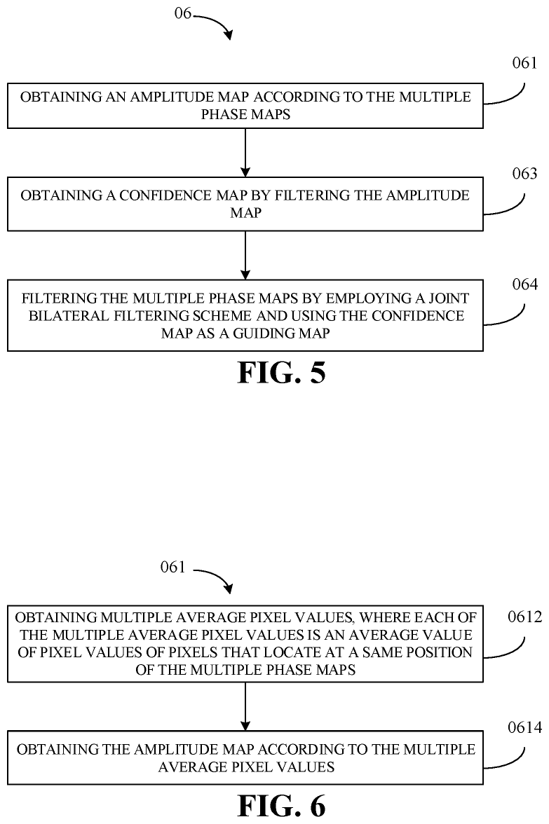

Referring to FIG. 5, in some implementations, the operation 06 includes the following.

At 061, an amplitude map is obtained according to the multiple phase maps.

At 063, a confidence map is obtained by filtering the amplitude map.

At 064, the multiple phase maps are filtered by employing the joint bilateral filtering scheme and using the confidence map as a guiding map.

Returning to FIG. 2, in some implementations, the processor 30 is configured to obtain the amplitude map according to the multiple phase maps, to obtain the confidence map by filtering the amplitude map, and to filter the multiple phase maps by employing the joint bilateral filtering scheme and using the confidence map as the guiding map.

That is, the operations 061, 063, and 064 can be implemented with the processor 30.

In an example, since there may be noise in the multiple phase maps, the amplitude map obtained according to the multiple phase maps may also have noise, and therefore, the amplitude map can be filtered to obtain the confidence map with less noise compared with the amplitude map. In this way, the confidence map is more accurate, and thus the more accurate confidence map can be used as the guiding map to achieve better filtering of the multiple phase maps with the joint bilateral filtering scheme. In this example, Gaussian filtering can be used to filter the amplitude map to obtain the confidence map.

Referring to FIG. 6, in some implementations, the operation 061 includes the following.

At operation 0612, multiple average pixel values are obtained, where each of the multiple average pixel values is an average value of pixel values of pixels that locate at a same position of the multiple phase maps.

At operation 0614, the amplitude map is obtained according to the multiple average pixel values.

Returning to FIG. 2, in some implementations, the processor 30 is configured to obtain the multiple average values, and to obtain the amplitude map according to the multiple pixel average values, where each average pixel value is an average value of pixel values of pixels that locate at a same position of the multiple phase maps.

That is, the operations 0612 and 0614 can be implemented with the processor 30.

Returning to FIG. 3, in an example, the multiple phase maps are in one-to-one correspondence, and an average value of pixel values of pixels that locate at a same location of the four phase maps may be obtained as an average pixel value in this location, for example, the average pixel value

$$Q = \frac{{Q}_{1} + {Q}_{2} + {Q}_{3} + {Q}_{4}}{4} .$$

The amplitude map and each of the four phase maps are also in one-to-one correspondence, and the average pixel value is regarded as a pixel value of a pixel that locates at this location of the amplitude map. The amplitude map can be obtained by acquiring pixel values of all pixels of the amplitude map according to the above operations 0612 and 0614.

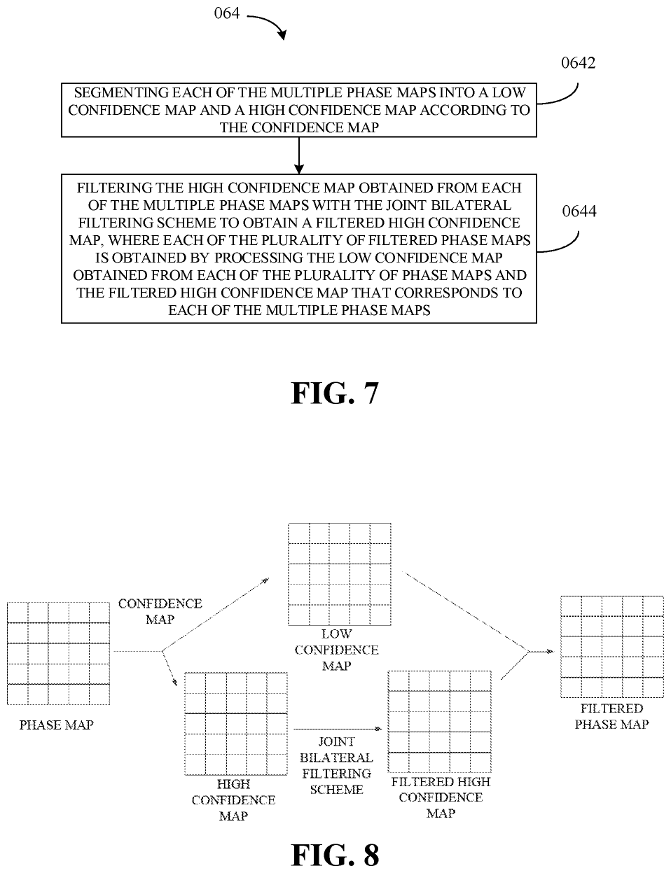

Referring to FIG. 7, in some implementations, the operation 064 includes the following.

At operation 0642, each of the multiple phase maps is segmented into a low confidence map and a high confidence map according to the confidence map.

At operation 0644, the high confidence map obtained from each of the multiple phase maps is filtered with the joint bilateral filtering scheme, to obtain a filtered high confidence map, where each of the plurality of filtered phase maps is obtained by processing the low confidence map obtained from each of the plurality of phase maps and the filtered high confidence map that corresponds to each of the multiple phase maps.

Returning to FIG. 2, in some implementations, the processor 30 is configured to segment each of the multiple phase maps into the low confidence map and the high confidence map according to the confidence map, to filter the high confidence map obtained from each of the multiple phase maps with the joint bilateral filtering scheme, to obtain a filtered high confidence map, where each of the plurality of filtered phase maps is obtained by processing the low confidence map obtained from each of the plurality of phase maps and the filtered high confidence map that corresponds to each of the multiple phase maps.

That is, the operations 0642 and 0644 can be implemented with the processor 30.

In an example, a confidence threshold can be set, and a pixel value of each pixel of the confidence map is compared with the confidence threshold. When the pixel value of one pixel of the confidence map is greater than or equal to the confidence threshold, confidence of the pixel is determined to be relatively high. When the pixel value of one pixel of the confidence map is less than the confidence threshold, confidence of the pixel is determined to be relatively low. In this way, multiple pixels of the confidence map can be divided into pixels with high confidence and pixels with low confidence, where each of the pixels with high confidence has a pixel value greater than or equal to the confidence threshold, and each of the pixels with low confidence has a pixel value smaller than the confidence threshold. Aliasing of the pixels with low confidence is serious. The aliasing is described as follows. When an actual distance is greater than the maximum distance that the apparatus 100 for acquiring a depth image can measure, a distance that the apparatus 100 can measure is indistinguishable. For example, when the maximum distance that the apparatus 100 for acquiring a depth image can measure is 1.5 meters and the actual distance is 1.6 meters, a distance measured by the apparatus 100 for acquiring a depth image is 0.1 meter.

Referring to FIG. 8, since the aliasing is likely to cause a large error in the multiple filtered phase maps, with the confidence map, an image area of each of the multiple phase maps having pixels that correspond to the pixels with low confidence is determined to be the low confidence map, and an image area of each of the multiple phase maps having pixels that correspond to the pixels with high confidence is determined to be the high confidence map. The high confidence map obtained from each of the multiple phase maps is filtered with the joint bilateral filtering scheme, and the low confidence map obtained from each of the multiple phase maps and the filtered high confidence map are spliced to obtain each of the multiple filtered phase maps. In this way, by segmenting out the low confidence map having serious aliasing, the high confidence map can be filtered accurately, so that each of the multiple phase maps formed by the low confidence map and the filtered high confidence map can be accurate.

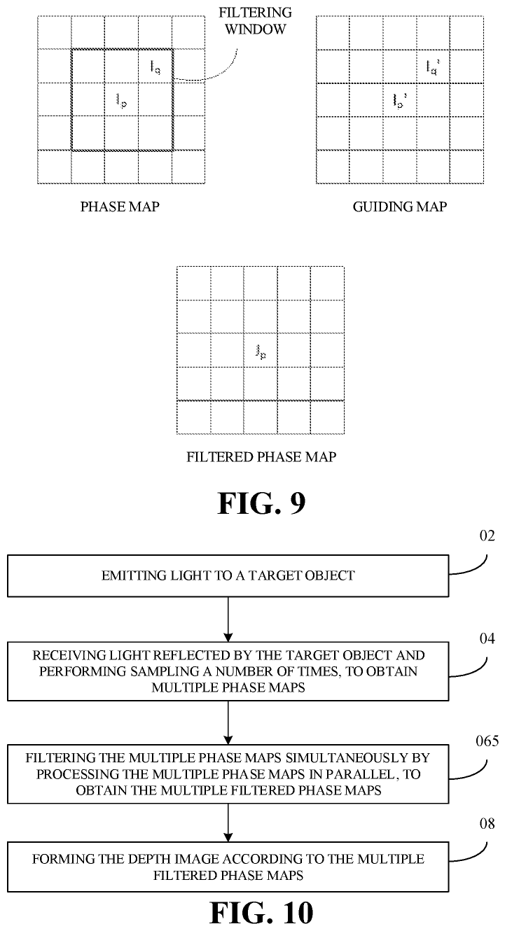

Referring to FIG. 9, in some implementations, the joint bilateral filtering scheme is defined as:

$${J}_{p} = \frac{1}{{k}_{p}} {\sum }_{q ∈ Ω} {I}_{q} f ( ‖ p - q ‖ ) g ( ‖ {I}_{p}^{′} - {I}_{q}^{′} ‖ ) ,$$

where kₚ=Σ_{q∈Ω}ƒ(∥p−q∥)g(∥Iₚ′−I_{q}′∥), Jₚ is an output pixel value, kₚ is a sum of weights, Ω is a filtering window, p is a coordinate of a pixel to-be-filtered of one of the multiple phase maps, q is a coordinate of a pixel of the one of the multiple phase maps that locates within the filtering window, I_{q} is a pixel value of the pixel indicated by q, Iₚ′ is a pixel value of a pixel of the guiding map that corresponds to the pixel to-be-filtered, I_{q}′ is a pixel value of a pixel of the guiding map that corresponds to the pixel indicated by q, and ƒ and g are weight distribution functions, where the weight distribution functions include a Gaussian function.

In an example, with the joint bilateral filtering scheme, according to a difference between the coordinate of the pixel to-be-filtered (the pixel to-be-filtered indicated by p) and the coordinate of the pixel (the pixel indicated by q) that locates within the filtering window, a first weight (ƒ(∥p−q∥)) is determined. For example, as illustrated in FIG. 9, the difference between the coordinate of the pixel to-be-filtered indicated by p and the coordinate of the pixel indicated by q can be 2. According to a difference between the pixel value Iₚ′ of the pixel of the guiding map that corresponds to the pixel to-be-filtered indicated by p and the pixel value I_{q}′ of the pixel of the guiding map that corresponds to the pixel indicated by q, a second weight (g(∥Iₚ′−I_{q}′∥)) is determined. The output pixel value Jₚ is determined according to the first weight and the second weight of each pixel that locates within the filtering window, the pixel value I_{q} of the pixel indicated by q of one of the multiple phase maps, and the sum of weights indicated by kₚ.

In some examples, f and g can be any weight distribution function, and can be the same or different. In the implementations of the disclosure, both f and g are Gaussian functions, and the Gaussian function is, for example, ƒ(x)=ae^{-(x-b)}^{²}^{/2c}^{²}, and a, b, and c are adjustment coefficients.

Referring to FIG. 10, in some implementations, the operation 06 includes the following.

At 065, the multiple phase maps are filtered simultaneously by processing the multiple phase maps in parallel, to obtain the multiple filtered phase maps.

Returning to FIG. 2, in some implementations, the processor 30 is configured to filter the multiple phase maps simultaneously by processing the multiple phase maps in parallel, to obtain the multiple filtered phase maps.

That is, the operation 065 can be implemented with the processor 30.

Since there are multiple phase maps, to improve the efficiency of filtering the multiple phase maps, the multiple phase maps can be processed in parallel to simultaneously filter the multiple phase maps. The multiple phase maps can be processed in parallel with openCL, a digital signal processor (DSP), or the like, which is not limited herein.

In some examples, after the depth image is formed, the depth image can further be subjected to anti-aliasing, mean filtering, and the like. The mean filtering can filter out salt and pepper noise in the depth image, so that the depth information of the depth image can be more accurate.

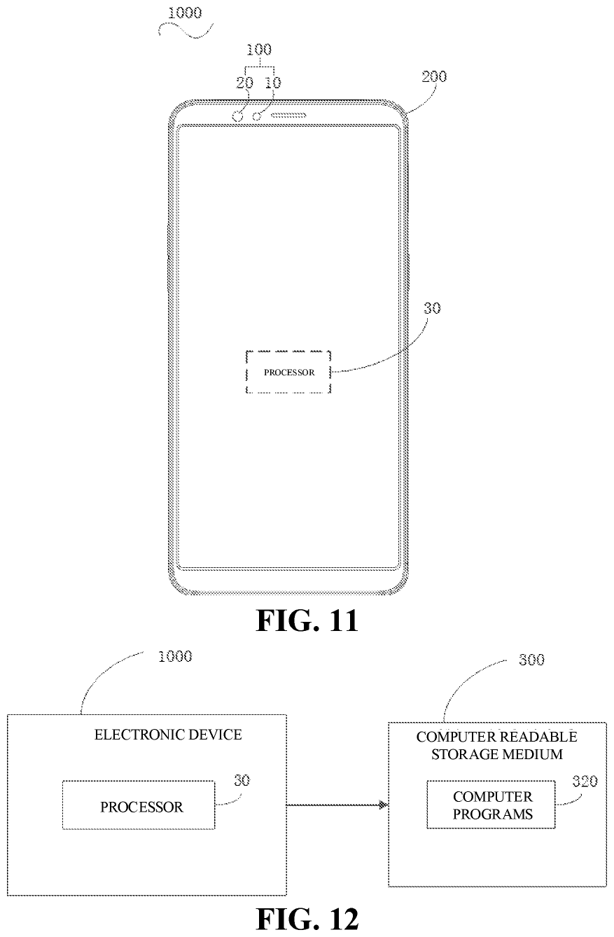

Referring to FIG. 11, an electronic device 1000 of implementations of the disclosure can include the apparatus 100 for acquiring a depth image of any of the above implementations. Furthermore, the electronic device 1000 further includes a casing 200. The apparatus 100 for acquiring a depth image is received in the casing 200. The casing 200 can provide the apparatus 100 for acquiring a depth image with protection against dust, water, and fall. The casing 200 defines a hole corresponding to the apparatus 100 for acquiring a depth image, to allow light to pass through the casing 200 via the hole. In another example, the apparatus 100 for acquiring a depth image is retracted into the casing 200 and can be stretched out of the casing 200. With this configuration, there is no need for the casing 200 to define a hole in a direction in which the light enters and exits the apparatus 100 for acquiring a depth image. When the apparatus 100 for acquiring a depth image is required to be used, the apparatus 100 for acquiring a depth image is stretched out of the casing 200; when the apparatus 100 for acquiring a depth image is not required to be used, the apparatus 100 for acquiring a depth image is retracted into the casing 200. In still another example, the apparatus 100 for acquiring a depth image is received in the casing 200 and located below a display screen. With this configuration, there is also no need for the casing 200 to define the hole in the direction in which the light enters and exits the apparatus 100 for acquiring a depth image.

The electronic device 1000 can be a mobile phone, a tablet computer, a smart wearable device (a smart watch, a smart wristband, a smart eyeglass, a smart helmet), a drone, etc., and is not limited herein.

Referring to FIG. 12, the disclosure further provides a computer readable storage medium 300. The computer readable storage medium 300 includes computer programs 320 operable with the electronic device 1000. The computer programs 320 are configured to be executed by the processor 30 to perform the method for acquiring a depth image of any of the above implementations.

In an example, with reference to FIG. 1 and FIG. 12, the computer programs 320 can be executed by the processor 30 to implement the following operations.

At operation 02, light is emitted to a target object.

At operation 04, light reflected by the target object is received and sampling is performed a number of times, to obtain multiple phase maps.

At operation 06, the multiple phase maps are filtered, to obtain multiple filtered phase maps.

At operation 08, the depth image is formed according to the multiple filtered phase maps.

In another example, with reference to FIG. 4 and FIG. 12, the computer programs 320 can further be executed by the processor 30 to implement the following operations.

At operation 061, an amplitude map is obtained according to the multiple phase maps.

At operation 062, the multiple phase maps are filtered by employing a joint bilateral filtering scheme and using the amplitude map as a guiding map.

In the description of the specification, the description of reference terms “an embodiment”, “some embodiments”, “examples”, “specific examples”, “some examples, or the like means that specific features, structures, materials, or characteristics described in connection with the embodiment or example is included in at least one embodiment or example of the disclosure. In the specification, the schematic representation of the above terms is not necessarily directed to the same embodiment or example. Furthermore, the specific features, structures, materials, or characteristics described may be combined in a suitable manner in any one or more embodiments or examples. In addition, without conflict, various embodiments or examples as well as features thereof described in the specification may be combined by those skilled in the art.

Moreover, the terms “first” and “second” are used for description only and are not to be construed as indicating or implying a relative importance or implicitly indicating the number of technical features indicated. Thus, features defining “first” or “second” may include at least one of the features, either explicitly or implicitly. In the description of the disclosure, the meaning of “multiple” and “a plurality of” is at least two, such as two, three, etc., unless specifically defined otherwise.

Any process or method description in the flowcharts or otherwise described herein may be understood to represent a module, segment, or portion of code that includes one or more executable instructions for implementing the operations of a particular logical function or process. Further implementations are included in the scope of the preferred embodiments of the disclosure. The functions may be performed in a substantially simultaneous manner or in a reverse order, depending on the order illustrated or discussed, which should be understood by those skilled in the art to which the embodiments of the present invention pertain.

Although the embodiments of the disclosure have been illustrated and described above, it is to be understood that the above-described embodiments are illustrative and are not to be construed as limiting the scope of the disclosure. Changes, modifications, alterations, and variations of the above-described embodiments are possible within the scope of the disclosure.

What is claimed is:

1. A method for acquiring a depth image, comprising:
emitting light to a target object;
receiving light reflected by the target object and performing sampling a number of times, to obtain a plurality of phase maps;
filtering the plurality of phase maps to obtain a plurality of filtered phase maps; and
forming the depth image according to the plurality of filtered phase maps.

2. The method of claim 1, wherein filtering the plurality of phase maps comprises:
obtaining an amplitude map according to the plurality of phase maps; and
filtering the plurality of phase maps by employing a joint bilateral filtering scheme and using the amplitude map as a guiding map.

3. The method of claim 2, wherein obtaining the amplitude map according to the plurality of phase maps comprises:
obtaining a plurality of average pixel values, wherein each of the plurality average pixel values is an average value of pixel values of pixels that locate at a same position of the plurality of phase maps; and
obtaining the amplitude map according to the plurality of average pixel values.

4. The method of claim 1, wherein filtering the plurality of phase maps comprises:
obtaining an amplitude map according to the plurality of phase maps;
obtaining a confidence map by filtering the amplitude map; and
filtering the plurality of phase maps by employing a joint bilateral filtering scheme and using the confidence map as a guiding map.

5. The method of claim 4, wherein filtering the plurality of phase maps by employing the joint bilateral filtering scheme and using the confidence map as the guiding map comprises:
segmenting each of the plurality of phase maps into a low confidence map and a high confidence map according to the confidence map; and
filtering the high confidence map obtained from each of the plurality of phase maps with the joint bilateral filtering scheme to obtain a filtered high confidence map, wherein each of the plurality of filtered phase maps is obtained by processing the low confidence map obtained from each of the plurality of phase maps and the filtered high confidence map that corresponds to each of the plurality of phase maps.

6. The method of claim 5, wherein segmenting each of the plurality of phase maps into the low confidence map and the high confidence map according to the confidence map comprises:
dividing a plurality of pixels of the confidence map into pixels with high confidence and pixels with low confidence, wherein each of the pixels with high confidence has a pixel value greater than or equal to a confidence threshold, and each of the pixels with low confidence has a pixel value smaller than the confidence threshold;
determining an image area of each of the plurality of phase maps having pixels that correspond to the pixels with high confidence to be the high confidence map; and
determining an image area of each of the plurality of phase maps having pixels that correspond to the pixels with low confidence to be the low confidence map.

7. The method of claim 5, further comprising:
obtaining each of the plurality of filtered phase maps by splicing the low confidence map and the filtered high confidence map.

8. The method of claim 4, wherein the joint bilateral filtering scheme is defined as:
$${J}_{p} = \frac{1}{{k}_{p}} {\sum }_{q ∈ Ω} {I}_{q} f ( ‖ p - q ‖ ) g ( ‖ {I}_{p}^{′} - {I}_{q}^{′} ‖ ) ,$$
and wherein
kₚ=Σ_{q∈Ω}ƒ(∥p−q∥)g(∥Iₚ′−I_{q}′∥),
Jₚ is an output pixel value,
kₚ is a sum of weights,
Ω is a filtering window,
p is a coordinate of a pixel to-be-filtered of one of the plurality of phase maps,
q is a coordinate of a pixel of the one of the plurality of phase maps that locates within the filtering window,
I_{q} is a pixel value of the pixel indicated by q,
Iₚ′ is a pixel value of a pixel of the guiding map that corresponds to the pixel to-be-filtered indicated by p,
I_{q}′ is a pixel value of a pixel of the guiding map that corresponds to the pixel indicated by q, and
ƒ and g are weight distribution functions, wherein the weight distribution functions comprise a Gaussian function.

9. The method of claim 8, wherein the weights comprise a first weight ƒ(∥p−q∥) and a second weight g(∥Iₚ′−I_{q}′∥), and wherein:
the first weight (ƒ(∥p−q∥)) is determined according to a difference between p and q, and
the second weight (g(∥Iₚ′−I_{q}′∥)) is determined according to a difference between the pixel value Iₚ′ and the pixel value I_{q}′.

10. The method of claim 1, further comprising:
filtering the plurality of phase maps simultaneously by processing the plurality of phase maps in parallel, whereby the plurality of filtered phase maps are obtained.

11. The method of claim 1, further comprising:
performing at least one of anti-aliasing and mean filtering on the depth image to obtain a depth image.

12. An apparatus for acquiring a depth image, comprising:
a light emitter, configured to emit light to a target object;
a light receiver, configured to receive light reflected back by the target object and perform sampling a number of times, to obtain a plurality of phase maps; and
a processor, configured to filter the plurality of phase maps to obtain a plurality of filtered phase maps and form the depth image according to the plurality of filtered phase maps.

13. The apparatus of claim 12, wherein the processor configured to filter the plurality of phase maps is configured to:
obtain an amplitude map according to the plurality of phase maps; and
filter the plurality of phase maps by employing a joint bilateral filtering scheme and using the amplitude map as a guiding map.

14. The apparatus of claim 13, wherein the processor configured to obtain the amplitude map according to the plurality of phase maps is configured to:
obtain a plurality of average pixel values, wherein each of the plurality average pixel values is an average value of pixel values of pixels that locate at a same position of the plurality of phase maps; and
obtain the amplitude map according to the plurality of average pixel values.

15. The apparatus of claim 12, wherein the processor configured to filter the plurality of phase maps is configured to:
obtain an amplitude map according to the plurality of phase maps;
obtain a confidence map by filtering the amplitude map; and
filter the plurality of phase maps by employing a joint bilateral filtering scheme and using the confidence map as a guiding map.

16. An electronic device comprising:
a casing; and
an apparatus received in the casing and comprising:
a light emitter, configured to emit light to a target object;
a light receiver, configured to receive light reflected back by the target object and perform sampling a number of times, to obtain a plurality of phase maps; and
a processor, configured to filter the plurality of phase maps to obtain a plurality of filtered phase maps and form a depth image according to the plurality of filtered phase maps.

17. The electronic device of claim 16, wherein the casing defines a hole corresponding to the apparatus for acquiring a depth image, to allow light to pass through the casing via the hole.

18. The electronic device of claim 16, wherein the apparatus for acquiring a depth image is retracted into the casing and is capable of stretching out of the casing and the casing defines a hole in a direction in which light enters and exits the apparatus for acquiring a depth image.

19. The electronic device of claim 18, wherein the apparatus for acquiring a depth image is stretched out of the casing when the apparatus for acquiring a depth image is required to be used, or the apparatus for acquiring a depth image is retracted into the casing when the apparatus for acquiring a depth image is not required to be used.

20. The electronic device of claim 16, wherein the apparatus for acquiring a depth image is received in the casing and located below a display screen and, for the casing, there is no hole defined in a direction in which light enters and exits the apparatus for acquiring a depth image.
